(19) United States
(12) Patent Application Publication
(10) Pub. No.: US 2009/0119188 A1
(43) Pub. Date: May 7, 2009

(54) MANAGEMENT OF EXCHANGE OF VIRTUAL GOODS FOR ONLINE GAMES

(75) Inventor: William G. Pagan, Durham, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/935,893

(22) Filed: Nov. 6, 2007

(51) Int. Cl. G06Q 30/00

(52) U.S. Cl. 705/27

(57) ABSTRACT

A method for validating and transferring a virtual good of an online game can be provided. The method can include reading a list of attributes of the virtual good provided by a seller of the virtual good and sending a message to a trusted server, wherein the message includes the list of attributes of the virtual good. The method can further include receiving a message from the trusted server confirming the existence of the virtual good, confirming the seller owns the virtual good and confirming the list of attributes. The method can further include receiving a payment confirmation from a payment authority, wherein payment was provided by a buyer of the virtual good. The method can further include sending a message to a trusted server instructing transfer of possession of the virtual good from the seller to the buyer.

### BACKGROUND OF THE INVENTION

1. Field of the Invention

The present invention relates to the field of online simulations and video games and more particularly relates to the field of management of the exchange of virtual goods for online simulations and video games.

2. Description of the Related Art

In recent years, the World Wide Web has experienced a rapid growth. In this regard, the web has begun to accommodate multiplayer games and simulations, known as online games. A plethora of multiplayer online games and simulations have appeared on the web, ranging from simple board games to complicated virtual reality worlds.

Online games and simulations can be classified according to the number of players that can play the game. There are single player online games and simulations in which only one player is involved and multiplayer online games and simulations in which a plurality of players are involved. MMOGs (Massively Multiplayer Online Games) are large-scale multiplayer online games and simulations that allow huge numbers of players to participate in game-play at once. MMOGs are truly massive and allow thousands of gamers to join the game world and simultaneously interact in that game. When users join the game they continue playing, regardless of who else is on at the same time. Each of a multitude of game servers in MMOGs usually hold at least a thousand players and the game servers run the environments for a particular part of the game world. Many MMOGs are made of several game servers, each providing a part of the world and will allow gamers to traverse between the game servers, thereby allowing gamers to travel to different parts of the game world. An MMORPG is a Massively Multiplayer Online Role Playing Game, which is an MMOG wherein the participants assume the roles of fictional characters and collaboratively create or follow stories

One of the features of many MMOGs is virtual goods, which include experience points, vehicles, weapons, credentials, permissions, virtual money and virtual gold. A player's online persona may obtain these virtual goods via game-play, purchase or other mechanisms. For example, as a player of a first person shooter completes various levels of the game, he obtains additional weapons, armor, outfits, experience points and permissions. Additional weapons and armor are beneficial as they may facilitate completion of levels and allow the player to perform in new and different ways. Additional permissions may unlock additional levels of the game or provide access to an otherwise hidden forum or stage. Whatever the items, players of MMOGs are constantly in search of virtual goods so as to enrich their game experience.

As a result of the wide desire for virtual goods, a cottage industry of virtual good marketplaces has sprung up. Players who have virtual goods can sell them on various sites and forums around the web. In other instances, players convene in person and bargain for the exchange of virtual goods. Virtual goods can be sold for money, exchanged for other virtual goods, or a combination of the two. Problems sometimes arise, however, when virtual goods are exchanged.

For example, it is desirable to validate the existence and ownership of the virtual good before an exchange occurs. Performing proper validation, however, can pose an obstacle. Full verification requires a potential purchaser of a virtual good to log onto the MMOG as the owner of the virtual good so as to verify the virtual good's existence and ownership. It may not be possible, however, to log onto the MMOG as the owner of the virtual good, and therefore full verification of the virtual good's existence and ownership may not occur. Thus, a buyer of a virtual good is left vulnerable to scams and unscrupulous sellers. In another example, it is desirable to verify certain attributes of a virtual good before the exchange occurs. Again, proper verification requires access to the seller's credentials, which may not be possible. Thus, many buyers must settle for less than full verification, which may result in falling victim to fraud or other deceptive practices.

Therefore, there is a need for improvements over the prior art, and more particularly, there is a need for a more efficient way of validating virtual goods so as to facilitate their exchange in a marketplace.

### BRIEF SUMMARY OF THE INVENTION

Embodiments of the present invention address deficiencies of the art in respect to validating virtual goods so as to facilitate their exchange in a marketplace. In one embodiment of the invention, a method for validating and transferring a virtual good of an online game can be provided. The method can include reading a list of attributes of the virtual good provided by a seller of the virtual good and sending a message to a trusted server, wherein the message includes the list of attributes of the virtual good. The method can further include receiving a message from the trusted server confirming the existence of the virtual good, confirming the seller owns the virtual good and confirming the list of attributes. The method can further include receiving a payment confirmation from a payment authority, wherein payment was provided by a buyer of the virtual good. The method can further include sending a message to a trusted server instructing transfer of possession of the virtual good from the seller to the buyer.

In another embodiment of the present invention, a computer program product comprising a computer usable medium embodying computer usable program code for validating and transferring a virtual good of an online game is provided. The computer program product includes computer usable program code for reading a list of attributes of the virtual good provided by a seller of the virtual good. The computer program product further includes computer usable program code for sending a message to a trusted server, wherein the message includes the list of attributes of the virtual good. The computer program product further includes computer usable program code for receiving a message from the trusted server confirming the existence of the virtual good, confirming the seller owns the virtual good and confirming the list of attributes. The computer program product further includes computer usable program code for receiving a payment confirmation from a payment authority, wherein payment was provided by a buyer of the virtual good. The computer program product further includes computer usable program code for sending a message to a trusted server instructing transfer of possession of the virtual good from the seller to the buyer.

In yet another embodiment of the invention, a server for validating and transferring a virtual good of an online game can be provided. The server can include a a web server for providing a web interface for reading a list of attributes of the virtual good provided by a seller of the virtual good. The server further can include a transmitter for sending a message to a trusted server, wherein the message includes the list of attributes of the virtual good. The server further can further include a receiver for receiving a message from the trusted server confirming the existence of the virtual good, confirming the seller owns the virtual good and confirming the list of attributes, wherein the receiver further receives payment confirmation from a payment authority, wherein payment was provided by a buyer of the virtual good. The server further can include a processor of the web server, the processor configured for sending a message to a trusted server instructing transfer of possession of the virtual good from the seller to the buyer.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is an illustration of a block diagram showing the network architecture of an application in accordance with the principles of the present invention;

FIG. 2 is a flow chart depicting the process by which a virtual good is validated and transferred, according to one embodiment of the present invention.

### DETAILED DESCRIPTION OF THE INVENTION

Embodiments of the present invention provide a method, server and computer program product for validating and transferring virtual goods so as to facilitate the exchange of virtual goods. In accordance with an embodiment of the present invention, a seller is provided with a forum, such as a web site, for posting his virtual good for sale. A buyer is provided with an opportunity to view the virtual good for sale on the forum. A method for validating the existence, ownership and stated attributes of the virtual good is further provided. If the virtual good is validated, the buyer is provided with an interface for entering payment credentials so as to provide payment for the virtual good. Lastly, if payment is received, a method for transferring ownership of the virtual good from the seller to the buyer is provided.

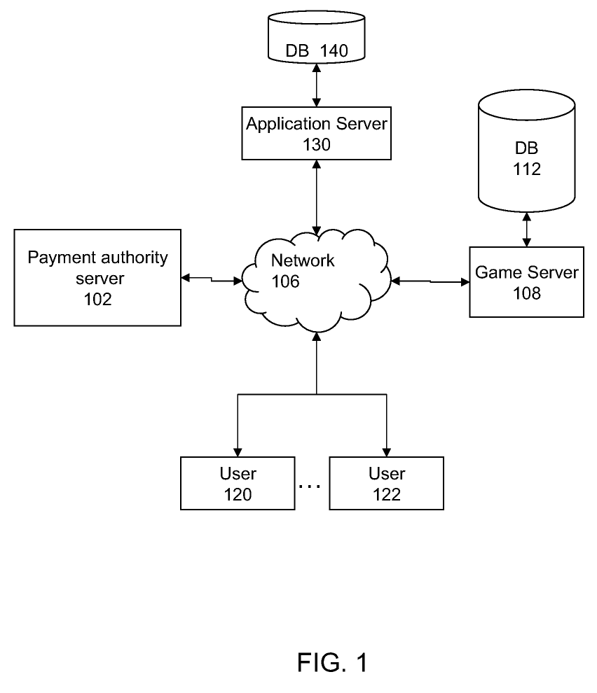

Referring now to the drawing figures in which like reference designators refer to like elements, there is shown in FIG. 1 an illustration of a block diagram showing the network architecture of an application in accordance with the principles of the present invention. The exemplary embodiments of the present invention adhere to the system architecture of FIG. 1. FIG. 1 shows an embodiment of the present invention wherein users 120-122 interact with application server 130 over a network 106, such as in an application service provider implementation.

FIG. 1 shows users 120-122 and application server 130 connected to a network 106 via client computers, such as desktop personal computers or servers. Payment authority server 102 and game server 108 provide additional functionality to the users 120-122. Application servers include a software engine that delivers applications to client computers. The application server 130 performs the virtual good validation and transference process as described in greater detail below. The game server 108 serves an online game or an MMOG to multiple players. The game server 108 may further provide verification of virtual good information, as described in greater detail below. In this patent application, the term “online game” is used to refer to any game, simulation, virtual world or any computer-based simulated environment that is accessed over a network, such as the global internet or the web.

Payment authority server 102 provides electronic funds transfer functions, which allow electronic financial transactions. The payment authority server 102 allows for cardholder-initiated transactions, where a cardholder makes use of a payment card, electronic payments by businesses, and electronic check clearing. An electronic funds transfer may be initiated by a cardholder when a payment card such as a credit card or debit card is used. This may take place at a point of sale or when the card is not present, such as for telephone orders and internet purchases.

The application server 130, payment authority server 102 and game server 108 may adhere to any commercially available server platform, such as the Sun Microsystems J2EE platform, a web-based application platform, an integrated platform for e-commerce or a content management system platform. It should be noted that although FIG. 1 shows only users 120-122 and one application server 130, the system of the present invention supports any number of users and servers connected via client computers. The application server 130 and its functions are described in more detail with reference to the figures below.

In one embodiment of the present invention, the application of application server 130 is a client-server application having a client portion that resides on the computers of users 120-122 and a server application that resides on application server 130. In another embodiment of the present invention, the client portion the application of application server 130 that resides on the computers of users 120-122 is simply a web browser. In another embodiment of the present invention, the game of game server 108 is an online multi-player video game, such as a first person shooter MMOG, which is played by users 120-122 via network 106.

FIG. 1 further shows application server 130 includes a database 140. FIG. 1 also shows that payment game server 108 includes a database 112. The databases 140, 112 are a repository for data used by application server 130 and game server 108 during the course of operation. The data stored in databases 140, 112 is described in greater detail below. The databases 140, 112 may adhere to any one of the flat model, hierarchical model, object-oriented model or a relational model for databases. Further, the databases 140, 112 can be any commercially database, such as an Oracle Database, Enterprise or Personal Edition, available from Oracle Corporation, or a Microsoft SQL Server or Access 2000 database available from Microsoft Corporation.

The databases 140, 112 may also include a database management system, which is an application that controls the organization, storage and retrieval of data (fields, records and files) in a database. A database management system accepts requests for data from a server and instructs the operating system to transfer the appropriate data. A database management system may also control the security and integrity of a database. Data security prevents unauthorized users from viewing or updating certain portions of a database. A database management system can be any commercially database management system, such as the Oracle E-Business Suite available from Oracle Corporation.

In an embodiment of the present invention, the computer systems of users 120-122 and application server 130 are one or more Personal Computers (PCs), Personal Digital Assistants (PDAs), hand held computers, palm top computers, lap top computers, smart phones, game consoles or any other information processing devices. A PC can be one or more IBM or compatible PC workstations running a Microsoft Windows or LINUX operating system, one or more Macintosh computers running a Mac OS operating system, or an equivalent. In another embodiment, the computer systems of users 120-122 and application server 130 are a server system, such as SUN Ultra workstations running a SunOS operating system or IBM RS/6000 workstations and servers running the AIX operating system.

In an embodiment of the present invention, the network 106 is a circuit switched network, such as the Public Service Telephone Network (PSTN). In another embodiment, the network 106 is a packet switched network. The packet switched network is a wide area network (WAN), such as the global Internet, a private WAN, a local area network (LAN), a telecommunications network or any combination of the above-mentioned networks. In yet another embodiment, the structure of the network 106 is a wired network, a wireless network, a broadcast network or a point-to-point network.

Application server 130 connects directly to the network 106 via a network interface, such as a network interface card. Alternatively, the application server 130 includes a web server that connects to the network 106 via a network interface. In this alternative, the application server 130 is logically connected to the web server, which provides a web interface available to clients (such as users 120, 122). This option is advantageous, as a web interface allows any clients having a web connection to connect to the application server 130 and payment authority server 102. A web interface provides a simple, efficient, highly compatible, economical and highly available connection to the application server 130 and payment authority server 102 to a wide range of clients.

FIG. 1 shows a group of users 120-122 connecting to the application server 130. These clients may execute client applications, such as compiled or interpreted executable modules written in C++, Java, Visual Basic, HTML, XML, Flash or separate Java applets, Java scriptlets, Java scripts, Perl scripts, Active X controls or any self-sufficient application executing on a client computer.

It should be noted that in the embodiment of the present invention described above, the application server 130 is depicted as separate from the payment authority server 102 and game server 108. In this embodiment, the application server 130, payment authority server 102 and game server 108 communicate over a network 106 or other communication medium. In an alternative embodiment of the present invention, any two or more of the application server 130, the payment authority server 102 and the game server 108 can be integrated. In this alternative embodiment, the integrated elements share the same resources.

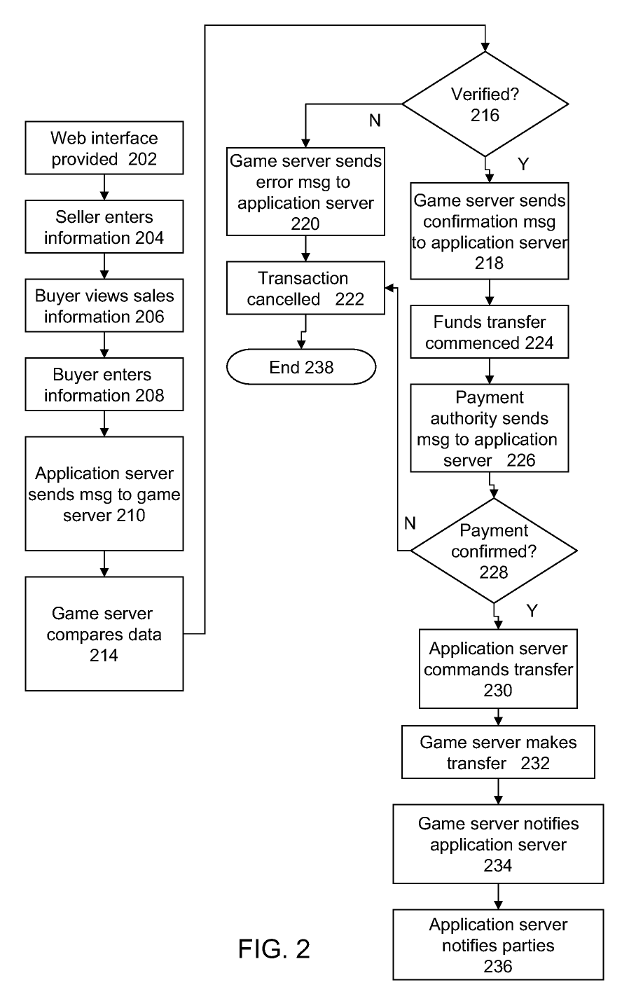

FIG. 2 is a flow chart depicting the process by which a virtual good is validated and transferred, according to one embodiment of the present invention. The flowchart of FIG. 2 describes the process effectuated by application server 130 of FIG. 1, so as to facilitate the exchange of a virtual good.

A virtual good may comprise any one of a character of an online game, an object of an online game, a weapon of an online game, a vehicle of an online game, virtual currency of an online game, experience points of an online game and permissions of an online game. A virtual good may further be any item or object that exists only in a game, which item can be obtained through playing an online game, purchasing the item in the online game or receiving the item from another player of the online game.

In step 202 of FIG. 2, a seller is provided with a forum, such as a web site, for posting his virtual good for sale. For example, a web page or set of web pages may be provided wherein the seller may enter information via text fields, buttons and various graphical user interface widgets.

In step 204, before entering the web site or being allowed to utilize the web site, the seller may be required to enter identifying information, such as his name, address, telephone number, email address, social security number, bank account number, banking institution name, banking institution address, banking institution telephone number, etc. Also in step 204, the seller may further be required to enter identifying information about the online game in which the virtual good exists. Thus, the seller may be required to enter the name of the online game of the virtual good, the web address of the online game, the IP address of the online game, and any other information necessary to locate the online game on the web.

Also in step 204, the seller may further be required to enter credentials for the online persona that owns the virtual good he intends to sell. Thus, the seller may be required to enter the name of the character (if any) that owns the virtual good, the user name or login name the seller uses, the password used by the seller for the user name, login name or character the seller provided and any other information necessary to locate or uniquely identify the entity that owns the virtual good the seller intends to sell.

Also in step 204, the seller may be required to enter information about the virtual good he intends to sell, such as a name of the virtual good, a unique identifier of the virtual good, an amount of the virtual good or any other attribute of the virtual good. Lastly, also in step 204, the seller may enter a desired price for the virtual good. Alternatively, the application server 130 sets the price for the virtual good according to a predefined schedule or algorithm,

In step 206, a buyer is provided with an opportunity to view the virtual good for sale on the forum. In step 208, before entering the web site or being allowed to utilize the web site, the buyer may be required to enter identifying information, such as his name, address, telephone number, email address, and social security number. The buyer may further be required to enter payment credentials such as his bank account number, banking institution name, banking institution address, banking institution telephone number, credit card number, credit card billing address, credit card expiration date and credit card security number. The buyer may further be required to enter credentials for the online persona that shall own the virtual good he intends to buy. Thus, the buyer may be required to enter the name of the character (if any) that shall own the virtual good, the user name or login name the buyer uses, the password used by the buyer for the user name, login name or character the buyer provided and any other information necessary to locate or uniquely identify the entity that shall own the virtual good the buyer intends to buy. For example, a web page or set of web pages may be provided wherein the buyer may enter information via text fields, buttons and various graphical user interface widgets.

In step 210, the application server 130 sends a message to the game server, wherein the message contains all or some of the information entered by the seller in step 204. At a minimum, the message may include an identifier of the seller, such as the seller's login name, and an identifier for the virtual good, such as the virtual good's name. The message may further include any attributes of the virtual good that were entered by the seller. Lastly, the message may further include any credentials entered by the seller. The location of the game server 108 was provided by the seller in step 204.

In step 214, the game server 108 compares the received information against the data stored in the database 112, which houses a database of game users, game user credentials, game user statistics and virtual goods owned by each game user. At a minimum, the game server 108 checks whether the virtual good identified in the message exists and whether the virtual good is owned by the seller. The game server 108 may further compare the attributes of the virtual good identified in the message against the data stored in the database 112. The game server 108 may further verify the credentials provided by the seller in step 204.

In step 216, the game server 108 determines whether the data in the message is true. If the result of this determination is positive, control flows to step 218. If the result of this determination is negative, control flows to step 220. In step 220, the game server 108 sends a message to the application server 130, wherein the message includes a non-confirmation or error message. In step 222, the application server 130 receives the message and cancels the transaction.

In an embodiment of the present invention, the verification process described in steps 210-216 may occur immediately after the seller enters information in step 204. In this embodiment, the virtual good being sold is verified before the buyer is provided with data about the virtual good.

In step 218, the game server 108 sends a reply message to the application server 130 confirming the data sent to the game server 108 in step 212. At a minimum, the game server 108 confirms in the reply message that the virtual good at issue exists and that the owner of the virtual good is the seller. The game server 108 may further confirm in the reply message any other data that was provided in the message send to the game server 108 in step 212.

In step 224, the application server 130 receives the message and initiates an electronic funds transfer process for the price of the virtual good, as set in step 204. The electronics funds transfer process of step 224 effectuates a transfer of funds from the buyer to the seller. Step 224 may include prompting the buyer to enter identifying information, such as his name, address, telephone number, email address, and social security number, if not already entered in step 208 above. The buyer may also be prompted to enter payment credentials such as his bank account number, banking institution name, banking institution address, banking institution telephone number, credit card number, credit card billing address, credit card expiration date and credit card security number, if not already entered in step 208 above. For example, a web page or set of web pages may be provided wherein the buyer may enter information via text fields, buttons and various graphical user interface widgets.

The electronics funds transfer process of step 224 includes the application server 130 sending some or all of the payment credentials described above to the payment authority server 102. The application server 130 may send the payment credentials to the payment authority server 102 in a message via the network 106.

In step 226, the payment authority server 102 sends a message via the network 106 to the application server 130. In step 228, the application server 130 determines whether the message from the payment authority server 102 confirms payment of the price of the virtual good being sold. If the result of this determination is positive, control flows to step 230. If the result of this determination is negative, control flows to step 222.

In step 230, the application server 130 sends a message to the game server 108 commanding the transference of the virtual good from the seller to the buyer. The message includes, at a minimum, an identifier of the seller, an identifier of the virtual good and an identifier of the buyer. The message may also include credentials of the seller and additional attributes of the virtual good, as specified by the seller in step 204 above. The message may also include credentials of the buyer, as specified by the buyer in step 208 above.

In step 232, game server 108 receives the message from the application server 130 and transfers possession of the virtual good from the seller to the buyer. In step 234, the game server 108 sends a message confirming the transfer to the application server 130. In step 236, the application server 130 notifies both the buyer and the seller that the transaction is complete. In step 238, the control flow of FIG. 2 ceases.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a RAM, a ROM, a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

I claim:

1. A method for validating and transferring a virtual good of an online game, comprising:
reading a list of attributes of the virtual good provided by a seller of the virtual good;
sending a message to a trusted server, wherein the message includes the list of attributes of the virtual good;
receiving a message from the trusted server confirming the existence of the virtual good, confirming the seller owns the virtual good and confirming the list of attributes;
receiving a payment confirmation from a payment authority, wherein payment was provided by a buyer of the virtual good; and
sending a message to a trusted server instructing transfer of possession of the virtual good from the seller to the buyer.

2. The method of claim 1, wherein the step of reading further comprises:
providing a web interface to the seller for providing an identifier of the seller and a list of attributes of a virtual good owned by the seller; and
reading a list of attributes of the virtual good provided by the seller of the virtual good, wherein the list of the attributes includes at least one of:
a name of the virtual good;
a unique identifier of the virtual good; and
an amount of the virtual good.

3. The method of claim 2, wherein the step of receiving a payment confirmation further comprises:
providing a web interface to the buyer for providing payment credentials;
sending the payment credentials to the payment authority; and
receiving a payment confirmation from the payment authority.

4. A computer program product comprising a computer usable medium embodying computer usable program code for validating and transferring a virtual good of an online game, comprising:
computer usable program code for reading a list of attributes of the virtual good provided by a seller of the virtual good;
computer usable program code for sending a message to a trusted server, wherein the message includes the list of attributes of the virtual good;
computer usable program code for receiving a message from the trusted server confirming the existence of the virtual good, confirming the seller owns the virtual good and confirming the list of attributes;
computer usable program code for receiving a payment confirmation from a payment authority, wherein payment was provided by a buyer of the virtual good; and
computer usable program code for sending a message to a trusted server instructing transfer of possession of the virtual good from the seller to the buyer.

5. The computer program product of claim 4, wherein the computer usable program code for reading further comprises:
computer usable program code for providing a web interface to the seller for providing an identifier of the seller and a list of attributes of a virtual good owned by the seller; and
computer usable program code for reading a list of attributes of the virtual good provided by the seller of the virtual good, wherein the list of the attributes includes at least one of:
a name of the virtual good;
a unique identifier of the virtual good; and
an amount of the virtual good.

6. The computer program product of claim 5, wherein the computer usable program code for receiving a payment confirmation further comprises:
computer usable program code for providing a web interface to the buyer for providing payment credentials;
computer usable program code for sending the payment credentials to the payment authority; and
computer usable program code for receiving a payment confirmation from the payment authority.

7. A server for validating and transferring a virtual good of an online game, comprising:
a web server for providing a web interface for reading a list of attributes of the virtual good provided by a seller of the virtual good;
a transmitter for sending a message to a trusted server, wherein the message includes the list of attributes of the virtual good;
a receiver for receiving a message from the trusted server confirming the existence of the virtual good, confirming the seller owns the virtual good and confirming the list of attributes, wherein the receiver further receives payment confirmation from a payment authority, wherein payment was provided by a buyer of the virtual good; and
a processor of the web server, the processor configured for sending a message to a trusted server instructing transfer of possession of the virtual good from the seller to the buyer.

8. The server of claim 7, wherein a virtual good comprises any one of a character of an online game, an object of an online game, a weapon of an online game, a vehicle of an online game, virtual currency of an online game, experience points of an online game and permissions of an online game.

9. The server of claim 8, wherein the web interface comprises:
a web page for entering, by the seller, an identifier of the seller and a list of attributes of the virtual good owned by the seller, wherein the list of the attributes includes at least one of:
a name of the virtual good;
a unique identifier of the virtual good; and
an amount of the virtual good.

10. The server of claim 9, further comprising:
a web interface provided to the buyer for entering payment credentials.
